(19) United States
(12) Patent Application Publication
(10) Pub. No.: US 2005/0187647 A1
(43) Pub. Date: Aug. 25, 2005

(54) Intelligent full automation controlled flow for a semiconductor furnace tool

(76) Inventors: Kuo-Hua Wang, Kaohsiung City (TW); Shun-An Chen, Sinshih Township (TW)

Correspondence Address: DUANE MORRIS, LLP;IP DEPARTMENT, ONE LIBERTY PLACE, PHILADELPHIA, PA, 19103-7396, US

(21) Appl. No.: 10/782,037

(22) Filed: Feb. 19, 2004

(51) Int. Cl. G06F 19/00

(52) U.S. Cl. 700/100

(57) ABSTRACT

The present invention relates to an apparatus and method for processing the flow of semiconductor wafers through a furnace tool having a front-opening unified pod (FOUP) material handling system. The invention provides for an automated control flow to realize greater efficiency and assure process quality. In one aspect of the invention the wafer batch completing its operation is discharged simultaneous with the charging of the next batch. Essentially the operation takes place by overlapping processing operations. An embodiment of the invention includes a process comprising the steps of: providing a first batch of semiconductor material, and loading the first batch into a carrier which transports the first batch into a semiconductor manufacturing process, and while the first batch undergoes the process, forming a second batch of semiconductor material, and pausing a second batch process operation until the first batch completes processing, to reduce the idle time of said process.

### BACKGROUND OF THE INVENTION

1. Field of the Invention

The present invention relates to methods for processing the flow of semiconductor wafers through a furnace tool having a front-opening unified pod material handling system (“FOUP”).

2. Description of the Prior Art

The present invention is drawn to a furnace utilized in the fabrication of semiconductor devices where materials in the form of wafers are batched and automatically conveyed into a processing chamber. As shown in FIG. 1, semiconductor wafers are transported by a transfer robot that serves as a conveying mechanism, that carries one batch of wafers via a transfer robot into a vacuum chamber to a wafer boat in the processing chamber through the gate that separates the chamber from the storage area. Wafers awaiting processing must sit idle until the current batch's process cycle is complete. Wafers are placed into the wafer boat and lifted by a boat elevator into a processing tube. The processing apparatus typically includes a load lock chamber, which vertically houses the wafer boat such that when the wafer boat is lifted into the process tube, the wafer boat closes the lower end of a manifold sealing the processing tube.

Once secured within the chamber the semiconductor wafers are subjected to gases and various atmospheric pressures and thereafter heated as required by various and sundry wafer fabrication processes. Once a wafer batch has been treated, the furnace is generally kept idle, while waiting for the wafers to cool and thereafter undergo inspection of the results of processing the batch. It is in this step in the fabrication process that batches, yet to be processed, are held in a queue awaiting to be fed into the wafer boat. Consequently, the furnace tool is underutilized and not usefully exploited because the boat is not loaded with the next batch into the boat before the current batch completes its inspection.

In the fully automated environment, a batch control signal from a process controller will trigger the automatic material handling system to transport the FOUP belonging to the batch to load the furnace tool and thereafter start the process. To maintain quality control, the next batch in the queue will not be charged into boat, until the current batch is determined to be within specification. This operation is typically performed in a monitor position or at an inspection station accessible to instrumentation and in some instances visual inspection. The process quality check decreases the efficiency of furnace tool use and increases the cost of material handling, generally.

### SUMMARY OF THE INVENTION

In one aspect of the invention, which overcomes prior art shortcomings, the wafer batch that is completing its operation, is discharged simultaneously with the loading of the next batch. Essentially the operation takes place by overlapping processing operations. More particularly, the method comprises the steps of: loading a semiconductor furnace tool with a first batch of semiconductor material into a conveyor and installing the first batch in a process chamber and while the first batch is in the chamber loading the conveyor with a second batch of semiconductor material and then halting any further operation on the second batch, pending the completion of an inspection of the first batch.

In yet another embodiment of the invention a process is adapted to heat and cool a substrate comprising the steps of: forming a first batch of semiconductor material, and loading the first batch into a conveyor, transferring the first batch to a heating mechanism, forming a second batch of semiconductor material, and loading the second batch into a conveyor, while heating the first batch positioned within the heating mechanism; transferring the first batch between a position proximate the heating mechanism and a position proximate the coolable member, cooling the first batch positioned proximate within a cooling mechanism; and while the first batch completes the process, transferring the second batch to a heating mechanism, to reduce the idle time of a processing unit.

### BRIEF DESCRIPTION OF THE DRAWING

The novel features of the present invention are set forth with particularity in the appended claims. The invention itself, however, both as to its organization and method of operation, together with further objects and advantages thereof, may be best understood by reference to the following description taken in conjunction with the accompanying drawings, in which:

FIG. 1 is a plan view of a process chamber and an automatic control flow apparatus.

FIG. 2 is a process diagram of the prior art sequential load process.

FIG. 3 is a process diagram of the present invention overlapping parallel load process.

FIG. 4 is a process diagram of the present invention.

FIG. 5 is a flow chart of the control of the present invention.

### DESCRIPTION OF THE PREFERRED EMBODIMENT

As previously indicated the furnace may be divided into two major parts: one a transfer unit and the other a tube unit. The transfer unit transfers wafers from the FOUP into the tube unit, removes wafer batches from the tube unit and moves the FOUP into and out of the tool. When tube unit is processing wafers, the transfer unit is typically in an idle state. When transfer unit is active, the tube is in an idle state. In most implementations of furnace, two or more batches may be stored on an internal buffer in the FOUP to reduce the idle time of transfer.

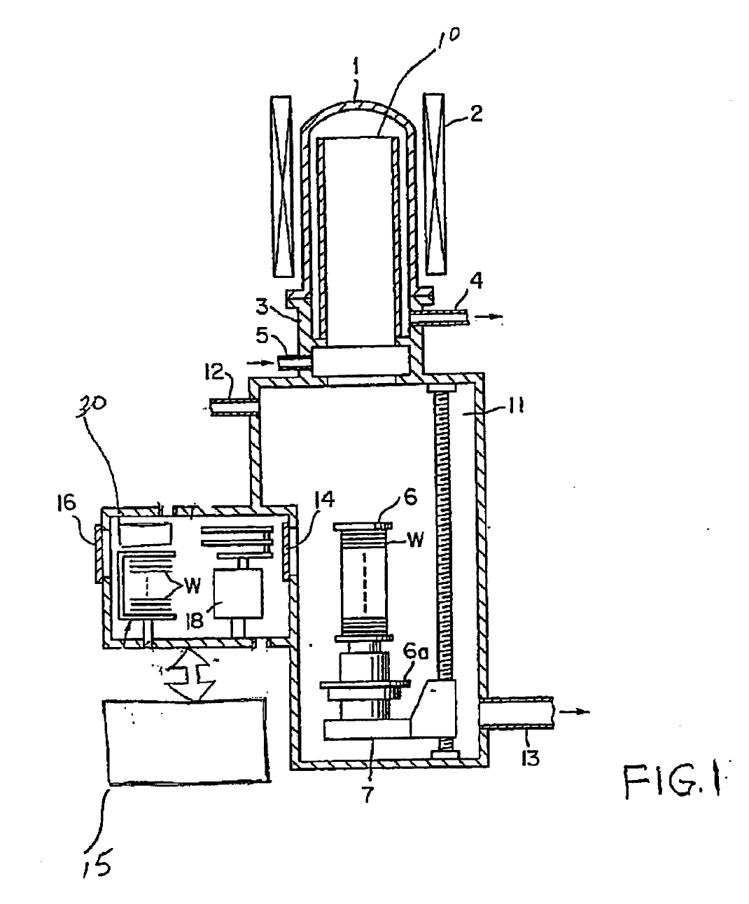

Referring to FIG. 1, in a front-opening unified pod furnace tool 1, semiconductor wafers W are transported by a transfer robot 18 that serves as a conveying mechanism, that carries one batch of wafers W via a transfer robot 18 into a vacuum chamber 11 to a wafer boat 6 in the chamber 11 through the gate 14. It is understood that the next batch of wafers W to be processed must await the current batch's process completion cycle. No other wafers are located within the furnace tool, until the current batch has been processed. Once the wafers are placed into the wafer boat 6 they are lifted by a boat elevator 7 into a process tube 10 for processing. The apparatus typically includes a load lock chamber 11, which vertically houses the wafer boat 6. When the wafer boat 6 is lifted into the process tube 10, a flange 6a on the lower end of the wafer boat 6 closes the lower end of a manifold 3 sealing the tube 10. When semiconductor wafers W are lifted into the tool 10 the ambient atmosphere is evacuated through an exhaust pipe 4 and when the interior of the tool 1 reaches preset vacuum, various process gases are fed into the chamber through a gas feed pipe 5 and thereafter heated as required by the particular treatment. Once the treatment cycle is complete, the process cycles again, whereby semiconductor wafers W are transported by the transfer robot 18, carrying one batch of wafers W via transfer robot 18 to the wafer boat 6 for processing. Note that the next batch of wafers W to be processed must await the previous batch process completion.

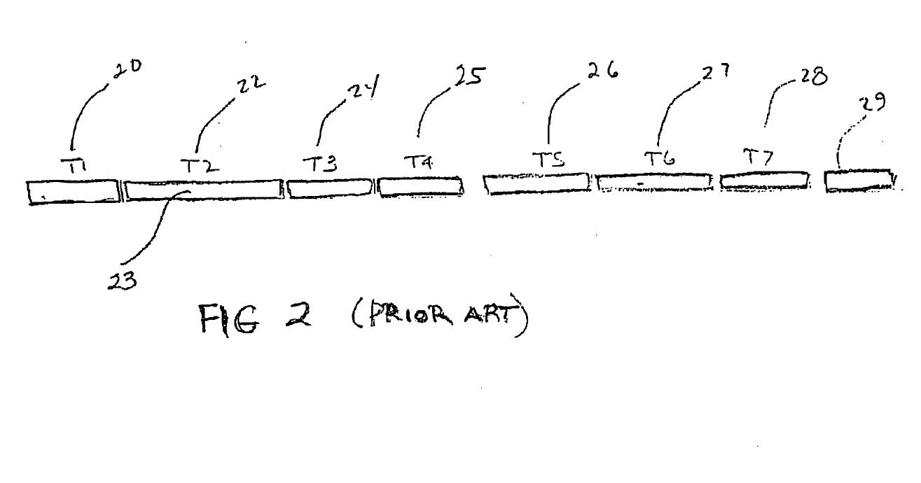

FIG. 2 illustrates the prior art furnace tool sequential processing wherein a first semiconductor batch 23 is processed as follows: (a) the FOUP 16 loads wafer batch 23 into an internal buffer 30 during T1 time 20; (b) wafers W charges during T2 time 22; (c) boat 6 travels vertically into the tube 10 during T3 time 24; (d) the batch 23 is subjected to a predetermined process during T4 time 25; (e) the boat 6 travels vertically downward out of the tube 10 during T5 time 26; the wafers W are cooled during T6 time 27 wafers W are discharged during T7 time 28; and the FOUP 16 unloads from internal buffer 30 during T8 time 29. In sequential processing the batches in the queue are unable to begin the load cycle.

The cooling step performed in wafer boat 6 after wafers are lowered from process tube 10 to chamber 11. The inspection station is next station of main process (furnace) in production line. The monitor wafer unloaded at first after cooling completed to perform inspection.

One aspect of the invention is drawn to a process for forming a first batch and loading the first batch into a conveyor, while a second batch completes processing to reduce the idle time of transfer into a processing unit. More particularly, in referring to FIG. 1, the process is adapted to heat and cool a semiconductor wafer substrate comprising the steps of: forming a first batch of semiconductor material W, and loading the first batch into a conveyor system comprised of an FOUP system 15 and 16, the transfer robot 18, transferring the first batch to a heating mechanism 10, forming a second batch of semiconductor material, and loading the second batch into a conveyor, while heating the first batch positioned within the heating mechanism 10; transferring the first batch between a position proximate the heating mechanism and a position proximate the coolable member (not shown), cooling the first batch positioned proximate within a cooling mechanism; and while the first batch completes the process, unloading monitor wafer at first to be inspected and transferring the second batch to a heating mechanism, to reduce the idle time of a processing unit.

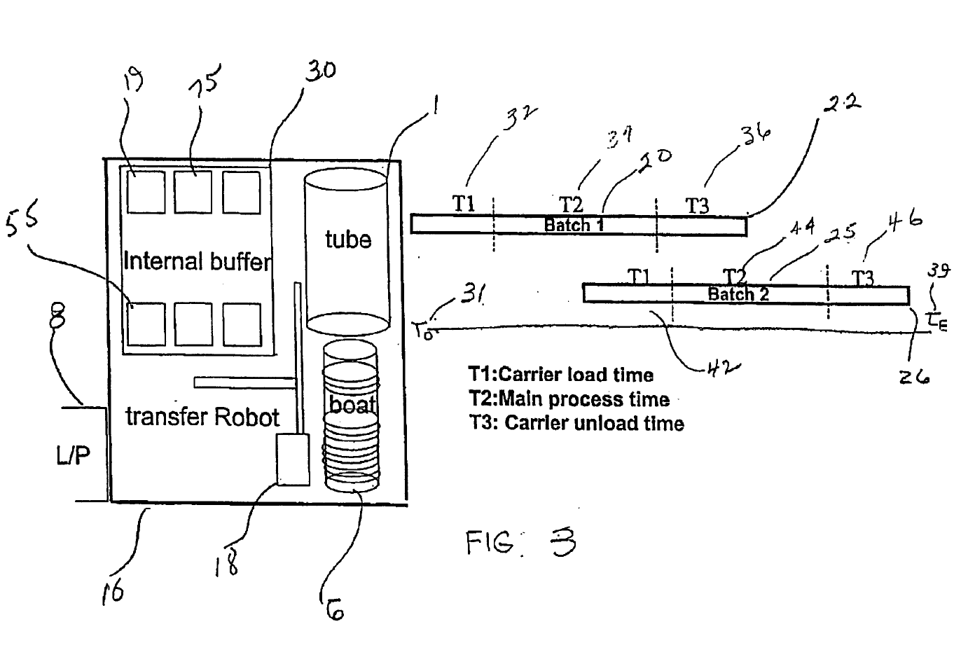

With reference to FIG. 3, to achieve improved efficiency, while maintaining product quality, controlled flow based process depends upon the following methodology: (a) forming a batch 25 and a charging or loading the batch 25 between the time that a conveyor, which in the preferred embodiment is referred to as boat 6, performs a vertical operation to remove a current batch 20 from tube 10; and subsequently cooling the batch 20, both steps of which, follow the operation that occurs in tube 10, thus serving to reduce the idle time of transfer robot 18 and increasing the utilization of tube 10. When tube 10 is in the processing state for batch 20, the transfer robot 18 loads and unloads the FOUP 16. In this way, the automatic material handling system has a greater time interval to transport FOUP 16 to the furnace tool 1; (b) additionally, discharging the current batch 20 and charging the subsequent batch 25 using tool robot 16 simultaneously overlapping (c) and pausing the material handling operation before boat 6 moves batch 25 vertically into the tube 10, until the monitored result of previous batch 20 is determined to be either satisfactory or unsatisfactory in meeting the prescribed specification, before resuming the previously paused operation.

Therefore, given the foregoing method to increase tool 1 utilization, FIG. 3 provides for overlapping the process period 22 with the sequential batch processing operation of process period 26 as a means to reduce transfer unit idle time as measured between T0 period 31 and TE period 39. The transfer unit 16 idles between the period during which the boat 6 moves vertically out of the tube 10 and cools the batch 20. In the present invention, the subsequent batch 25 is loaded during this period without encountering a conflict with the processing of the current batch 20.

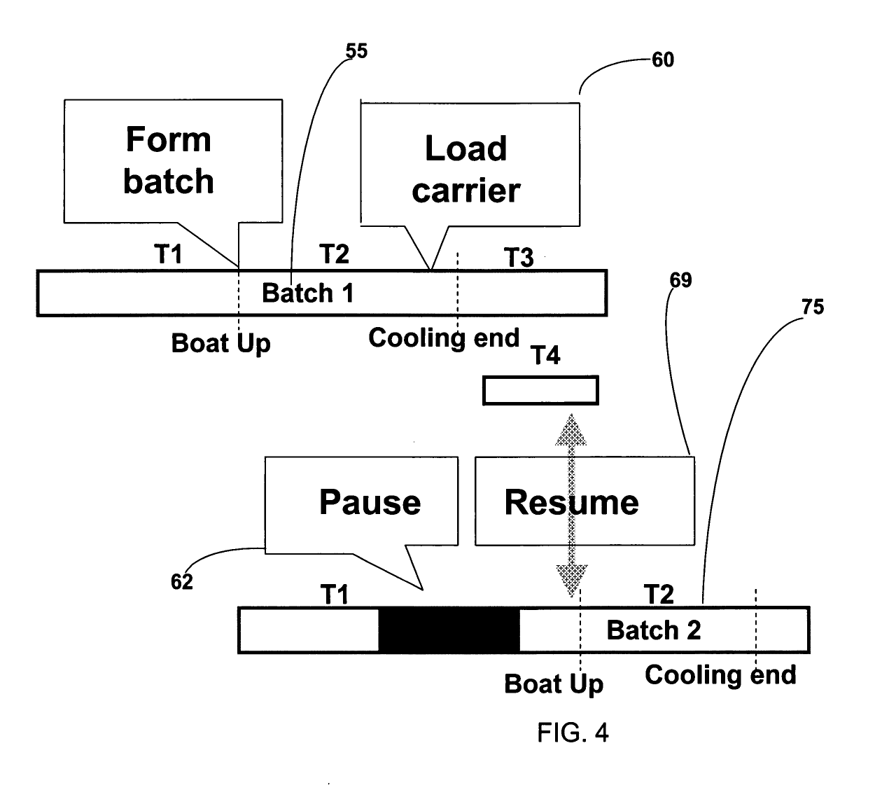

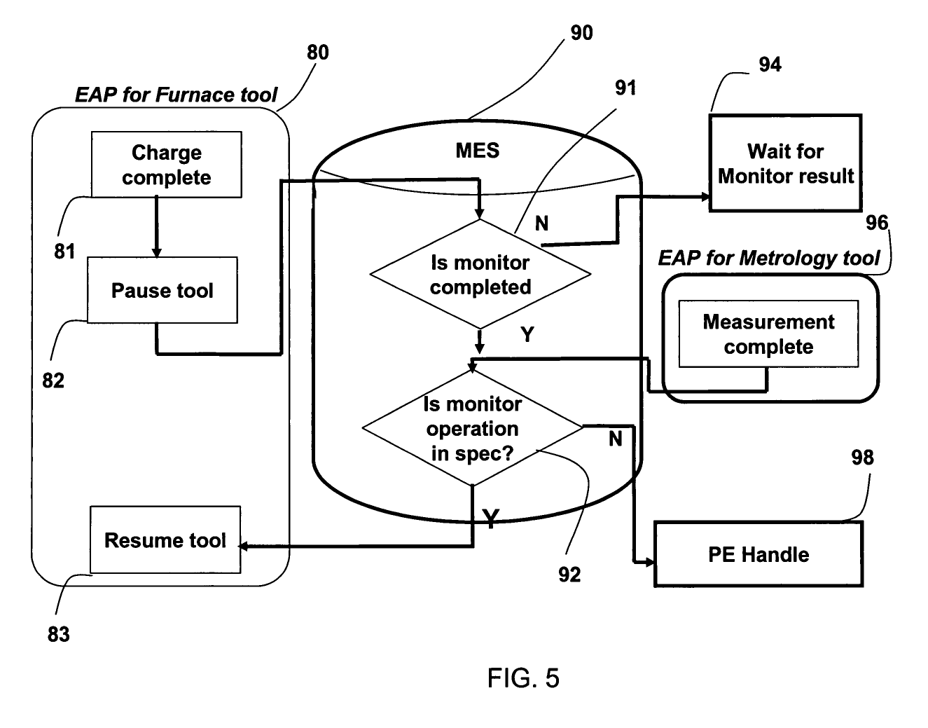

Referring to FIG. 4 and FIG. 5, a material executive control system (“MES”) 90 forms the batch 55 upon receiving a control signal initiated by the automatic control apparatus 15 which initiates a step change to boat 6, causing it to move vertical into the tube 10, followed by a control signal from the automatic control apparatus 15, which triggers the FOUP 16 to transport subsequent batch lots, such as batch 75 into position for processing in the furnace tool 1. When a carrier is present on a load port, (see, FIG. 1, 8) the FOUP 16 transfer unit dedicates itself to loading the carrier into internal buffer 30, where a plurality of batches such as batch 19 ready for processing in tube 10 are stored.

A batch 75 that was previously stored in the internal buffer 30 begins operation and only awaits the tube 20 availability and thereby performs a wafer loading operation. Upon the tube 20 availability, the cooled batch 55 starts to discharge 60. Once the tube unit 20 starts to discharge 60 the cooled batch 55 and the batch 55 leaves the monitor position, the transfer unit 18 can, in an overlapping fashion, execute the next batch 75. The batch 55 in the monitor position will be discharged 60 and unloaded from tool 1, following specification qualification.

In the process flow of furnace tool 1 operation, the batch 55 will enter the boat 6 up or vertical operation step, after the wafer W charge or load into the boat 6 is complete. As part of the process control, a pause 62 and resume control 64 apparatus ensures process quality. When the batch 75 is ready for processing, the boat 6 is move up or vertically into the tube 10, where it is first paused pending the monitor result of previous batch 55. Upon completion of the inspection or monitor operation, batch 75 is loaded into the boat 6 and moved up vertically into the tube 10.

In accordance with the foregoing an embodiment of the invention includes a process comprising the steps of: providing a first batch of semiconductor material 20, and loading the first batch into a carrier 18 which transports the first batch into a semiconductor manufacturing process 1, and while the first batch undergoes the process, forming a second batch of semiconductor material 25, and pausing a second batch 25 process operation until the first batch 20 completes processing, to reduce the idle time of said process.

In yet another embodiment of the present invention the method of control of the semiconductor processing comprises the steps of: loading a first batch of semiconductor material into a transport, conveyor or carrier and installing the first batch in a process chamber before a second batch of semiconductor material has been processed and cooled. Referring to FIG. 4 and FIG. 5, the sequential batch control flow is as follows: the furnace tool 1 loads batch 55 into boat 6 and installs batch 55 in tube 10. While batch 55 is resident in tube 10, the boat 6 is charged 81 from transfer robot 18 and then paused 82 pending the completion of the MES operation 90. The automatic control apparatus 15 determines if the monitor operation has been completed 91 and if it has been, then the process operation proceeds to determine if the batch 55 is in specification 92. If the monitor operation 91 is not complete, then the automatic control apparatus 15 causes the process to remain in a wait state 94, until the monitor operation 91 is complete. If the batch 55 during the monitoring operation 92 is determined not within specification, then a process engineer manually intervenes 98. The automatic control apparatus 15 of furnace tool 10 thereby increases the speed of operation by not requiring the FOUP to load and wafer charge before the processing operation on batch 55 is completed.

While preferred embodiments of the invention have been shown and described herein, it will be understood that such embodiments are provided by way of example only. Numerous variations, changes, and substitutions will occur to those skilled in the art without departing from the spirit of the invention. Accordingly, it is intended that the appended claims cover all such variations as fall within the spirit and scope of the invention.

1. A process comprising the steps of:
providing a first batch of semiconductor material, and loading the first batch into a carrier for transport into a semiconductor manufacturing process, and while the first batch undergoes the manufacturing process, providing a second batch of semiconductor material, and pausing a second batch process operation until the first batch completes processing, to reduce the idle time of said process.

2. A process comprising the steps of:
loading a first batch of semiconductor material into a carrier and installing the first batch in a process chamber and while the first batch is in the chamber charging the carrier with a second batch of semiconductor material, and pausing further operation of the second batch, while inspecting the first batch.

3. The process according to claim 2, further comprising the step of:
determining if the inspection is satisfactory.

4. The process according to claim 2, further comprising the step of:
determining if the inspection is unsatisfactory.

5. The process according to claim 2, further comprising the step of:
determining when to resume operation.

6. The method according to claim 2, further comprising the step of:
determining when to resume operation, based upon the result of the inspection of the first batch.

7. A process comprising the steps of:
loading a second batch of semiconductor material into a conveyor and installing the second batch in a process chamber before a first batch of semiconductor material has been processed and cooled.

8. A process adapted to heat and cool a substrate comprising the steps of:
forming a first batch of semiconductor material, and loading the first batch into a carrier, transferring the first batch to a heating mechanism, forming a second batch of semiconductor material, and loading the second batch into the carrier, while heating the first batch positioned within the heating mechanism; transferring the first batch between a position proximate the heating mechanism and a position proximate the coolable member, cooling the first batch positioned proximate within a cooling mechanism; and while the first batch completes the process, transferring the second batch to the heating mechanism, to reduce the idle time of the process.
